(19) United States
(12) Patent Application Publication
(10) Pub. No.: US 2011/0159202 A1
(43) Pub. Date: Jun. 30, 2011

(54) Method for Sealing Pores at Surface of Dielectric Layer by UV Light-Assisted CVD

(75) Inventors: Kiyohiro Matsushita, Tokyo (JP); Yosuke Kimura, Tokyo (JP); Ippei Yanagisawa, Tokyo (JP)

(73) Assignee: ASM JAPAN K.K., Tokyo (JP)

(21) Appl. No.: 12/953,870

(22) Filed: Nov. 24, 2010

Related U.S. Application Data
(60) Provisional application No. 61/290,631, filed on Dec. 29, 2009.

(51) Int. Cl. C08J 7/18

(52) U.S. Cl. 427/509

(57) ABSTRACT

A method for sealing pores at a surface of a dielectric layer formed on a substrate, includes: providing a substrate on which a dielectric layer having a porous surface is formed as an outermost layer; placing the substrate in an evacuatable chamber; irradiating the substrate with UV light in an atmosphere of hydrocarbon and/or oxy-hydrocarbon gas; sealing pores at the porous surface of the dielectric layer as a result of the irradiation; and continuously irradiating the substrate with UV light in the atmosphere of hydrocarbon and/or oxy-hydrocarbon gas until a protective film having a desired thickness is formed on the dielectric layer as a result of the irradiation.

### CROSS-REFERENCE TO RELATED APPLICATIONS

This application claims the benefit of U.S. Provisional Application No. 61/290,631, filed Dec. 29, 2009, the disclosure of which is herein incorporated by reference in its entirety.

### BACKGROUND

1. Field of the Invention

The present invention generally relates to restoration of damage caused to a porous low-k film by ILD patterning steps, such as resist ashing, plasma cleaning, etc.

2. Description of the Related Art

As the device design rule has been reduced, dielectric constants of inter-layer insulation films continue to fall and 32-nm generation and newer devices are now achieving dielectric constants of less than 2.5. As the dielectric constants of dielectric films (low-dielectric-constant films, or “low-k films”) fall, however, porosities are increasing and consequently the trend for lower dielectric constants is giving rise to problems resulting from higher porosities of inter-layer insulation films, such as lower resistance to plasma and chemical solutions and diffusion of barrier metal into the film. Since low-k films are exposed to chemicals during etching, resist ashing, wet cleaning and other steps in the wire machining process, insufficient resistance to chemical solutions may lead to higher dielectric constants due to inappropriate machined shapes, moisture absorption, etc.

To solve this problem, a technology to form a thin film to seal pores (pore seal) is required so as to repair the side walls of low-k films that have been damaged by dry etching and plasma ashing and also to prevent the film walls from being damaged again by subsequent wet cleaning or etching of etching stopper film.

### SUMMARY

In general, a damaged layer has lost carbon in the film and become hydrophilic, and can therefore cause the dielectric constant to rise if moisture is absorbed later on. This necessitates a repair process comprising, for example, removing absorbed moisture and adding CHx to the damaged areas to make the film hydrophobic in those areas. Also, a step to form a protective film is required after the repair process in order to protect the side walls of the low-k film against damage in the subsequent steps. This protective film must be resistant to plasma and chemical solutions and able to protect porous low-k films with a film thickness of 1 to several nm, and is generally formed via the PECVD or ALD technology. The PECVD process generally allows a film to form quickly, but controlling the film thickness to a range of 1 to several nm is difficult and coverage of height gaps is also poor. On the other hand, the ALD process provides excellent controllability of film thickness and coverage of height gaps, but formation of film is slow and the throughput is low. ALD is also disadvantageous in terms of cost because it requires expensive apparatuses.

To solve the aforementioned problems, the inventors of the present invention developed a technology to repair damaged layers while forming a pore seal film at the same time using a UV irradiator. In an embodiment, the present invention is characterized as follows:

1) A substrate is exposed to an atmosphere of UV reaction gas and irradiated with UV light.

2) The UV reaction gas contains CHx and adds CHx to damaged layers of a low-k film through UV reaction, thereby making the layers hydrophobic.

3) A protective film is formed over side walls of the low-k film as a result of continuous UV reaction.

4) The protective film has a dielectric constant of less than 3.0, or less than 2.5, and has minimum impact on the effective dielectric constant between wires.

In the above, a protective film is formed from hydrocarbon and/or oxy-hydrocarbon gas by UV light-assisted CVD.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are oversimplified for illustrative purposes and are not necessarily to scale.

FIG. 1 is a schematic view of a UV system usable in an embodiment of the present invention.

FIG. 2 is a graph showing the relationship between thickness of UV light-assisted CVD film and UV light irradiation time according to an embodiment of the present invention.

FIG. 3 is a graph showing chemical diffusion rates of low-k film (ELK), top-covered low-k film (PS-ELK, Top), and top- and side-covered low-k film (PS-ELK, Top+Side) according to an embodiment of the present invention.

FIG. 4 shows FT-IR spectra of films which have been subjected to oxygen plasma treatment (“Post O2 plasma treatment”); oxygen plasma treatment+thermal annealing (“Thermal annealing”); oxygen plasma treatment+UV restoration (“UV restoration”, an embodiment of the present invention); and UV cure (“Post UV cure”), respectively.

FIG. 5 is a graph showing the relationship between delta k value and FT-IR—OH area intensity of film subjected to oxygen plasma treatment (“O2 plasma treatment”), film subjected to thermal annealing (“Thermal annealing”), and film subjected to UV restoration (“UV restoration”, an embodiment of the present invention).

FIGS. 6A to 6D show changes of concentrations (atom %) of carbon (FIG. 6A), silicon (FIG. 6B), oxygen (FIG. 6C), and hydrogen (FIG. 6D) in relation to depth of the oxygen plasma treated film (“O2 damaged”), the reference film (“Reference”, no oxygen plasma treatment), and the UV-restored film (“Restored”, an embodiment of the present invention).

### DETAILED DESCRIPTION

In some embodiments, at least one of the following features is realized.

1) Damage to a low-k film is repaired using the UV film deposition technology and a protective film (pore seal) is formed continuously.

2) A UV reaction gas is used.

3) The UV reaction gas contains CHx groups.

4) The substrate is exposed to the atmosphere of this UV reaction gas and irradiated with UV light to form a polymer film.

5) The polymer film obtained through UV reaction has a dielectric constant of less than 3.0.

6) UV film deposition is implemented in an ambience of vacuum to atmospheric pressure.

7) The substrate temperature is from room temperature to 400° C.

8) Heat treatment is performed on the formed film, if necessary.

In an embodiment, the present invention provides a method for sealing pores at a surface of a dielectric layer formed on a substrate, comprising: (i) providing a substrate on which a dielectric layer having a porous surface is formed as an outermost layer; (ii) placing the substrate in an evacuatable chamber; (ii) irradiating the substrate with UV light in an atmosphere of hydrocarbon and/or oxy-hydrocarbon gas; (iv) sealing pores at the porous surface of the dielectric layer as a result of the irradiation; and (v) continuously irradiating the substrate with UV light in the atmosphere of hydrocarbon and/or oxy-hydrocarbon gas until a protective film or layer having a desired thickness is formed on the dielectric layer as a result of the irradiation. In the above, “continuously” refers to without breaking a vacuum, without interruption as a timeline, without changing treatment conditions, immediately thereafter, as a next step, or without a discrete physical or chemical boundary between two structures in some embodiments. In some embodiments, “film” refers to a layer continuously extending in a direction perpendicular to a thickness direction substantially without pinholes to cover an entire target or concerned surface, or simply a layer covering a target or concerned surface. In some embodiments, “layer” refers to a structure having a certain thickness formed on a surface, a film-like structure having pinholes or similar discontinued portions, or a synonym of film. In this disclosure, any defined meanings do not necessarily exclude ordinary and customary meanings in some embodiments.

In this disclosure, “gas” may include vaporized solid and/or liquid and may be constituted by a mixture of gases. In this disclosure, “hydrocarbon and/or oxy-hydrocarbon gas” may refer to a gas constituted mainly or predominantly by C, H, and optionally O. In this disclosure, the reaction gas, the additive gas, and the inert gas may be different from each other or mutually exclusive in terms of gas types, i.e., there is no overlap of gases among these categories. Further, in this disclosure, any ranges indicated may include or exclude the endpoints.

In some embodiments, the pores are sealed at the porous surface of the dielectric layer solely as a result of the UV irradiation.

In some embodiments, the step of sealing the pores is performed to restore a surface layer of the substrate while forming substantially no film thereon (“substantially no film” or the like refers to a film having a thickness of less than about 0.1 nm or less than about 0.05 nm in some embodiments). In some embodiments, the surface layer of the substrate is restored at a depth of about 5 nm to about 50 nm (typically about 10 nm to about 35 nm) where the pores are sealed with carbon and hydrogen derived from the hydrocarbon and/or oxy-hydrocarbon gas. In some embodiments, the protective film is hydrophobic wherein the quantity of OH bonds is substantially reduced as compared with the quantity of OH bonds obtained as a result of oxygen plasma treatment or thermal annealing (“substantially reduced” or the like refers to a reduction by more than 50% or more than 75% in some embodiments). In some embodiments, the porous surface of the dielectric layer undergoes chemical degradation or damage prior to the step of sealing the pores, but the UV restoration treatment can effectively restore the damaged layer. In some embodiments, the chemical degradation is etching, ashing, or cleaning.

In some embodiments, the atmosphere of hydrocarbon and/or oxy-hydrocarbon gas may be established by introducing a hydrocarbon and/or oxy-hydrocarbon gas into the evacuatable chamber. In an embodiment, the hydrocarbon and/or oxy-hydrocarbon gas may consist of hydrogen and carbon but, may include impurities or substances immaterial to the UV restoration process. In an embodiment, the hydrocarbon and/or oxy-hydrocarbon gas may consist of a mixture of hydrocarbon gas and oxy hydrocarbon gas but may include impurities or substances immaterial to the UV restoration process.

In some embodiments, the hydrocarbon and/or oxy-hydrocarbon gas may be introduced with an inert gas saturated with hydrocarbon and/or oxy-hydrocarbon gas. In an embodiment, the saturated inert gas may be introduced at a flow rate of 500 sccm to 10,000 sccm.

In some embodiments, the protective film may have a thickness of about 0.1 nm to about 6 nm (preferably about 0.1 nm to about 5 nm, or about 0.5 nm to about 2 nm).

In some embodiments, the UV light may have a wavelength of 200 nm or higher.

In some embodiments, the method may further comprise annealing the substrate after the UV light irradiation.

In some embodiments, the protective film may be formed on a top surface and side surfaces of the dielectric layer.

In some embodiments, the dielectric layer may be a SiCO film.

In some embodiments, the dielectric layer may have a dielectric constant of lower than 2.5. In an embodiment, the protective film and the dielectric layer together may have a dielectric constant which is substantially the same as that of the dielectric layer (“substantially the same” or the like refers to a difference of less than 10%, 5%, or 1% in some embodiments, or a difference of less than 0.2 or 0.1 as a dielectric constant value in some embodiments).

In the disclosure, the protective film may also be referred to as “a UV light-assisted CVD film,” “UV polymer film,” “pore seal film,” “skin layer,” or the like in some embodiments. Further, the sealing of pores may also refer to UV restoration or simply restoration.

In some embodiments, the porous low-k film is etched and wiring grooves are patterned, after which areas damaged by processing in the previous stage are repaired by means of UV film deposition and then a pore seal film of approx. 1 to 2 nm in thickness is formed over the side walls of the low-k film. This way, the low-k film can be protected against damage in the subsequent etching step for etching stopper film and also against plasma damage due to Cu reduction, etc., while preventing the barrier metal from diffusion.

As a specific example, a porous low-k film is exposed to an atmosphere of UV reaction gas to irradiate UV light onto a substrate through an irradiation window designed to pass UV light through it. The UV reaction gas reacts with UV light to form a film on the substrate. The UV reaction gas contains substitution groups that react with UV light, such as C═C and C═0 and has the property to polymerize as a result of UV irradiation. Once a UV film is formed, the pores are sealed and diffusion of chemical solution into the porous low-k film can be suppressed.

Types of reaction gases that can be used to form a UV polymer film include, for example, CxHy gas (x=1 to 15, y=2× or 2x+2, such as styrene monomer, butadiene, etc.), CxHyOz gas (x=1 to 15, y=2× or 2x+2, O=1 to 3, such as acetone, ethanol, methanol, butanol, etc.), or mixed gas constituted by CxHy and N2 or other inert gas, or by CxHy, CxHyOz and N2 or other inert gas, among others. In an embodiment, a CH—containing reaction gas (not including Si-containing gas) is selected primarily because it allows for easy cleaning of products attached to the inside of the reactor after the film has been formed, where these products can be cleaned using oxygen radicals and ozone without using any F-containing gas (in the examples explained below, oxygen was radicalized using a remote plasma unit and then the obtained radicals were supplied to the reactor for cleaning). Although Si-containing precursors can repair damage and seal pores, cleaning of reaction products of Si-containing precursors requires F-containing gases. However, any UV reactor having an irradiation window made of synthetic quartz will have its irradiation window damaged by such F-containing gases. Since F-containing gases cannot be used to clean the reactor, use of Si-containing precursors is not appropriate with such a reactor. In other words, in an embodiment the present invention is characterized in that it allows for use of synthetic quartz as well as cleaning without using any F-containing cleaning gas.

In an embodiment, porous low-k films targeted by the present invention include those having the following characteristics, for example:

Type of film: SiOC film (regardless of whether the film is formed by PECVD, ALD or PEALD);

Dielectric constant: Less than 2.5;

Film density: 0.5 to 1.5 g/cm3 (desirably less than 1.2 g/cm3);

Porosity: 10% or more (desirably 20% or more);

Film thickness: 50 to 500 nm (a desired film thickness can be selected as deemed appropriate according to the application and purpose of film, etc.).

Note that with normal wiring structures, an etching stopper film of SiCN, etc., is formed on top of the ILD film of ELK, etc. Accordingly, in some embodiments the present invention also encompasses forming a protective film (base protection film) of SiN, SiC, SiCN, SiCO, etc., on the low-k film. The thickness of this base protection film is approx. 5 to 100 nm (desirably 5 to 30 nm).

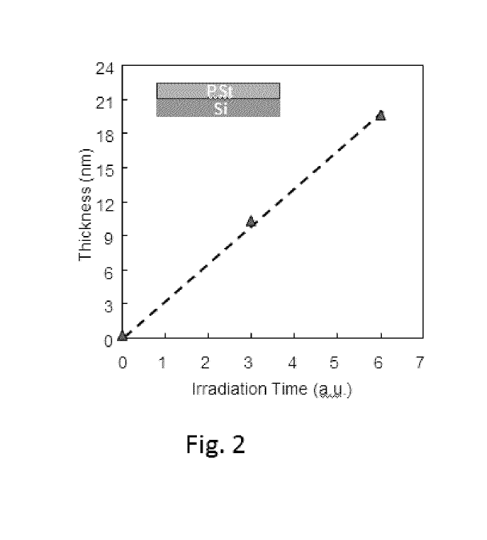

In addition, in an embodiment a single step is used, instead of two separate steps, to achieve hydrophobization via UV irradiation and to form a film also via UV irradiation. In other words, a film continues to be deposited and its thickness continues to grow over time while hydrophobization is in progress by means of UV irradiation, as shown in FIG. 2, meaning that there is no way to determine when hydrophobization ends and when film deposition starts. Rather, it can be considered that film deposition starts the moment hydrophobization is started and therefore hydrophobization is integrated with UV deposition of polymer film.

In an embodiment, the UV film deposition conditions shown in Table 1 are used.

TABLE 1

| | UV irradiation/polymerization |
|---|---|
| UV wavelength (nm) | >200 nm (preferably 200 to 600 nm) |
| UV power (W/cm²) | 10 to 400 mW/cm² (preferably 50 to |
| | 200 mW/cm²) |
| Deposition time (sec) | 5 to 500 sec (preferably 30 to 300 sec) |
| Substrate temperature | 100 to 450° C. (preferably 200 to 300° C.) |
| (° C.) | |
| Pressure (Torr) | 0 to 760 Torr (preferably 1 to 10 Torr) |
| Flow rate of reaction | 5 to 1000 sccm (preferably 10 to 100 sccm) |
| gas (sccm) | |
| Type of carrier gas | N2 gas, He, Ar |
| Flow rate of carrier | 100 to 10000 sccm (preferably 100 to 2000 sccm) |
| gas including reaction | |
| gas (sccm) | |
| Other additive gases | O2, CO2, H2O |

Types of lamps that can be used to irradiate UV light include, for example, high-pressure mercury lamp, low-pressure mercury lamp, xenon excimer lamp and metal halide lamp.

Illumination intensity, heater temperature, gas flow rate, mixing ratio and deposition time are among the parameters used to control the thickness and quality of UV polymer film, and the film thickness and film quality can be controlled by changing these parameters. In UV film deposition, the deposition rate can be controlled even with a thin film and ILD film quality is expected to improve due to the annealing effect.

Annealing, which is used in an embodiment, may be carried out under the conditions shown in Table 2, for example:

TABLE 2

| | Thermal annealing |
|---|---|
| Temperature (° C.) | 100 To 450 (preferably 200 |
| | to 300 C.) |
| Pressure (torr) | 0 To 760 |
| | Torr (preferably 1 to 10 torr) |
| Atmosphere | N2, He, Ar, H2 |
| Duration (seconds) | 10 sec To |
| | 1800 sec (preferably 60 to |
| | 300 sec) |

In an embodiment, the obtained UV film is characterized by a specific dielectric constant of 2.0 to 4.0 (desirably less than 2.5), for example.

In the present disclosure where conditions and/or structures are not specified, the skilled artisan in the art can readily provide such conditions and/or structures, in view of the present disclosure, as a matter of routine experimentation. Also, in the present disclosure, the numerical numbers applied in specific embodiments can be modified by a range of at least ±50% in other embodiments, and the ranges applied in embodiments may include or exclude the endpoints.

### EXAMPLES

### Example 1

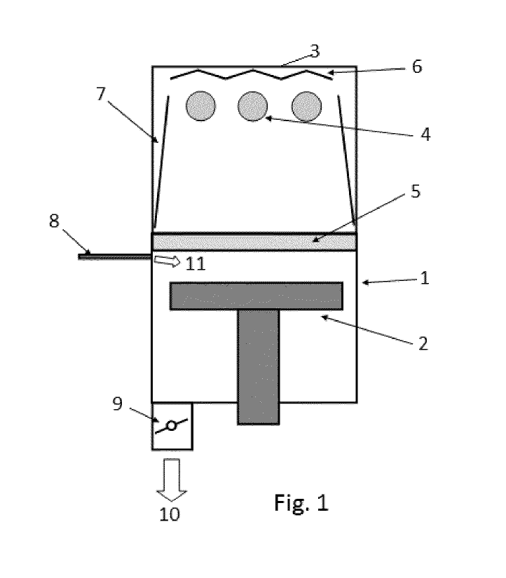

In this example, the apparatus shown in the schematic diagram of FIG. 1 was used to form a film.

As shown in FIG. 1, the UV irradiation apparatus used in this example comprises a UV lamp unit 3, UV irradiation window 5, vacuum reactor 1, heater table 2, process gas inlet tube 8, process gas inlet port 11, vacuum pump 10, and pressure control valve 9. The UV lamp unit 3 has UV mirrors 6, 7 for efficient irradiation of UV light. Note that multiple process gas inlet ports may be provided at roughly an equal pitch along the inner periphery walls of the reactor to allow gas to be introduced toward the center from the inner periphery walls of the reactor.

Note that the present invention is not at all limited to the apparatus shown in this figure and any other apparatus can be used so long as it can irradiate UV light. The apparatus shown comprises a chamber that can be controlled to pressures from vacuum to around atmospheric pressure, and a UV irradiation unit provided on top of the chamber.

This apparatus is explained further with reference to FIG. 1. The apparatus shown in FIG. 1 comprises UV emitters that emit light continuously and in a pulsed manner, a heater installed in a manner opposed to and in parallel with the emitters, and an irradiation window glass lying between the UV emitters and heater in a manner opposed to and in parallel with them. The irradiation window is provided to achieve uniform UV irradiation and may be made of any material, such as synthetic quartz, capable of isolating the reactor from the atmosphere but letting UV light pass through it. The UV emitters in the UV irradiation unit are multiple units of tube shape that are arranged in parallel with one another, where, as shown in FIG. 1, these emitters are arranged in an appropriate manner to achieve their purpose of ensuring uniform irradiation, while a reflector (umbrella-shaped piece on top of the UV lamp) is provided to have the UV light from each UV emitter reflect properly on the thin film, with the angle of this reflector made adjustable to achieve uniform irradiation. In this apparatus, the chamber that can be controlled to pressures from vacuum to around atmospheric pressure, and the UV emitters installed in the chamber and emitting light continuously and in a pulsed manner, are separated as the substrate processing part and UV emission part via the flange with the irradiation window glass. The UV emitters are structured in such a way that they can be replaced with ease.

Method of Experiment

The following experiment was conducted using the apparatus shown in FIG. 1.

1) A Si wafer (300 mm in diameter) on which a porous low-k film (k2.4 siloxane polymer film of 500 nm in film thickness, 25% in porosity and 1.2 g/cm³ in density) had been formed via plasma CVD was transported to the heater table in the reactor under atmospheric pressure. The heater table temperature was 25° C.

2) Next, the first material or specifically a styrene monomer, and the second material or specifically N2 gas saturated with acetone, were supplied continuously to the reactor (at 1 slm).

3) UV light with a wavelength of 200 nm or more (type of UV lamp: high-pressure mercury lamp) was irradiated (irradiation power: 30 mW/cm²) onto the Si wafer for a specified period via the UV irradiation glass (made of quartz).

4) Thereafter, annealing was performed for a specified period (5 minutes) in a N2 ambience at 400° C. under 5 Ton vacuum.

FIG. 2 shows the relationship of the thickness of the UV-formed polymer film on one hand, and the UV irradiation time on the other. Note that the horizontal axis in FIG. 2 is based on an arbitrary time unit (A.U.) and the actual time is calculated by multiplying the time in A.U. by 10 minutes. As can be seen, the polymer film deposition rate is dependent on the UV irradiation time. Also examined was how forming a polymer film on a porous low-k film (ELK) would affect the ELK film, and the results are shown in Table 3.

TABLE 3
Effects of UV Polymer Film on Quality of Porous Low-k Film
(ELK)

| | Dielectric | Leak current density |
|---|---|---|
| | constant | (A/cm²@2 MV/cm) |
| Before polymer film was formed | 2.40 | 3.8E−8 |
| After polymer film (2 nm) was formed | 2.39 | 1.9E−9 |

Since the dielectric constant of the polymer film itself ranged from approx. 2.3 to 2.5, forming this film would not have any impact on the dielectric constant. On the other hand, the leak current dropped significantly.

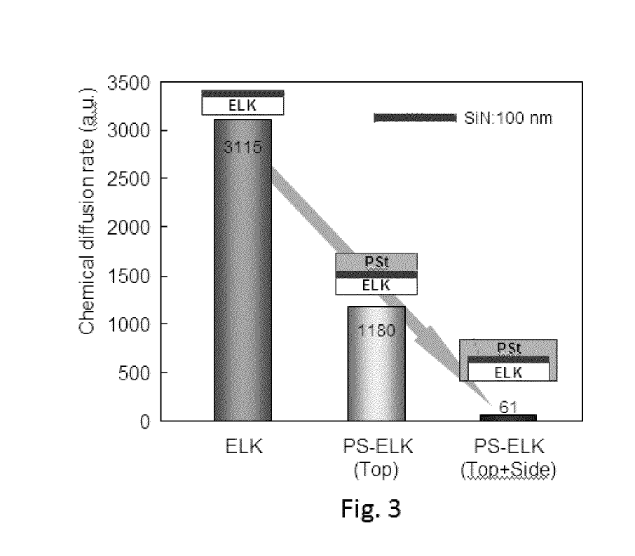

FIG. 3 shows the measured results of diffusion rates of chemical solution in samples, being a porous low-k film (k2.4) and combinations of the same porous low-k film having a polymer film (2 to 3 nm) formed on top by UV irradiation. Note that the ELK film was 500 nm thick, while the SiN film was 100 nm thick, and the UV polymer film deposition conditions for PS-ELK (Top) were the same as those shown in FIG. 2, where the deposition time was 10 minutes. The deposition conditions for PS-ELK (Top+Side) were also the same as those shown in FIG. 2, where the deposition time was 10 minutes.

As for the sample preparation method, a piece of low-k film cut into a rectangular shape was UV-deposited with film to obtain the PS-ELK (Top+Side) sample having a PS film (or PSt film, polystyrene film) formed on its top and side faces. The four side faces of this sample were then cut to expose the substrate surface to obtain the PS-ELK (Top) sample. Note that in the figure, SiN was provided only for convenience to measure the diffusion rate of chemical solution, because presence of SiN allows for visual observation of discoloration in areas where chemical solution has diffused, thereby enabling measurement of the diffusion distance.

The diffusion rate of chemical solution was measured as follows:

1) Form a SiN or SiCN cap film on the wafer on which the target film has been formed.

2) Cut the wafer into a rectangular shape (2×2 cm).

3) Soak the cut rectangular sample in chemical solution (toluene or other solvent) for a specified period.

4) Remove the sample and measure the width of the area that has discolored due to penetration of chemical solution, and then divide the measured width by the time to calculate the diffusion rate.

As shown in FIG. 3, while the diffusion rate of the control porous low-k film was approx. 3000, the sample having a UV film formed only on its top layer had a diffusion rate of only approx. 40% of the original film, while the sample having a UV film also formed on its side faces had a diffusion rate of as low as approx. 2%. These results indicate that the pores of the porous low-k film were sealed by the polymer film. The etching rates of porous low-k film and UV polymer film in 1:200 BHF are shown in Table 2. Clearly, the UV polymer film did not dissolve in BHF, indicating high chemical resistance.

TABLE 4
Etching Rates of Porous Low-k Film and UV Polymer Film in
BHF

| | Etching rate in 1:200 BFH (a.u.) |
|---|---|
| Porous low-k film | 40 |
| UV polymer film | ~0 |

### Example 2

According to the procedures and conditions used in Example 1, substrates having a porous layer (ELK film) were prepared, on which the following treatments were conducted, respectively:

1) Oxygen Plasma Treatment:

The ELK film was exposed to an oxygen plasma for 20 sec, which was generated by an RF power (13.56 MHz, 50 W) applied to oxygen-supplying gas (O2, 7 sccm) at a temperature of 250° C. at a pressure of 3.5 Torr.

2) Uv Restoration:

According to the procedures and conditions used in Example 1, the oxygen plasma treated ELK film obtained in 1) was subjected to UV restoration treatment where the temperature of the heating table was 300° C., the pressure was 10 Ton, nitrogen gas (500 sccm) and hydrocarbon gas (butadiene, 90 sccm) were introduced, and the substrate was irradiated with UV light for 4 minutes.

3) Thermal Annealing:

The oxygen plasma treated ELK film obtained in 1) was annealed at a temperature of 300° C. for five minutes in an atmosphere of nitrogen at a pressure of 5 Torr.

4) UV Cure:

The ELK film (without the oxygen plasma treatment) was irradiated with UV light (a wavelength of 200 nm to 400 nm, 100 W/cm2) for 4 minutes at a temperature of 400° C. at a pressure of 5 Ton.

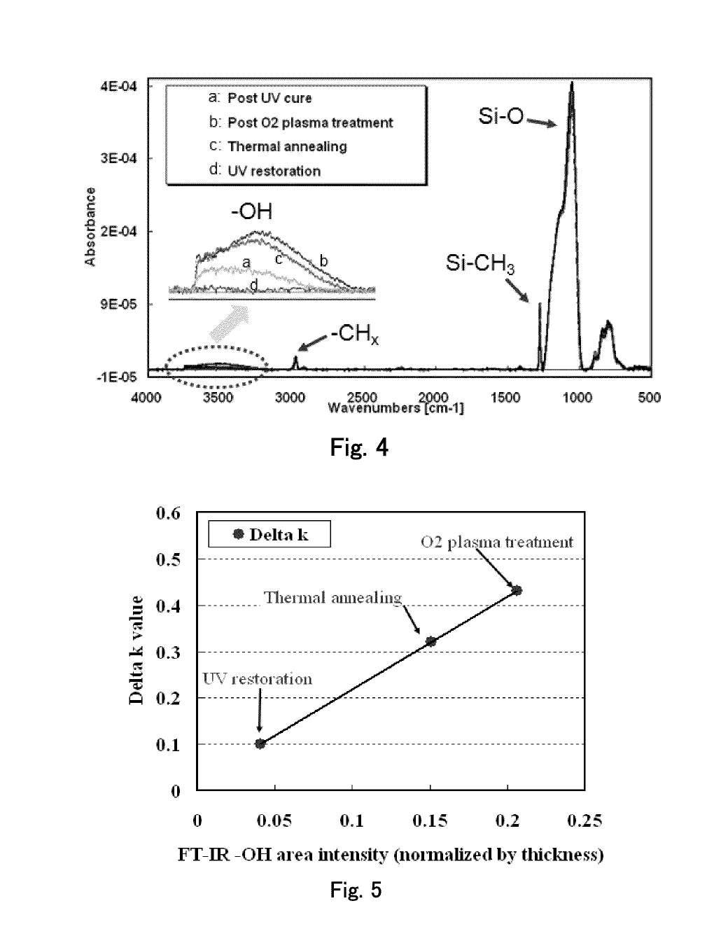

FIG. 4 shows FT-IR spectra of the ELK films which have been subjected to the oxygen plasma treatment (“Post O2 plasma treatment”); the oxygen plasma treatment+the thermal annealing (“Thermal annealing”); the oxygen plasma treatment+the UV restoration (“UV restoration”, an embodiment of the present invention); and the UV cure (“Post UV cure”), respectively. As shown in FIG. 4, —OH area intensity of the UV-restored film was significantly lower than that of the O2 plasma treated film and that of the thermally annealed film, although the overall spectra were substantially the same. It is revealed that the UV restoration was the most effective in reducing —OH in the film by activation and restructure of chemical bonds. The UV-cured film had lower —OH area intensity than that of the UV-restored film since no oxygen plasma damage occurred.

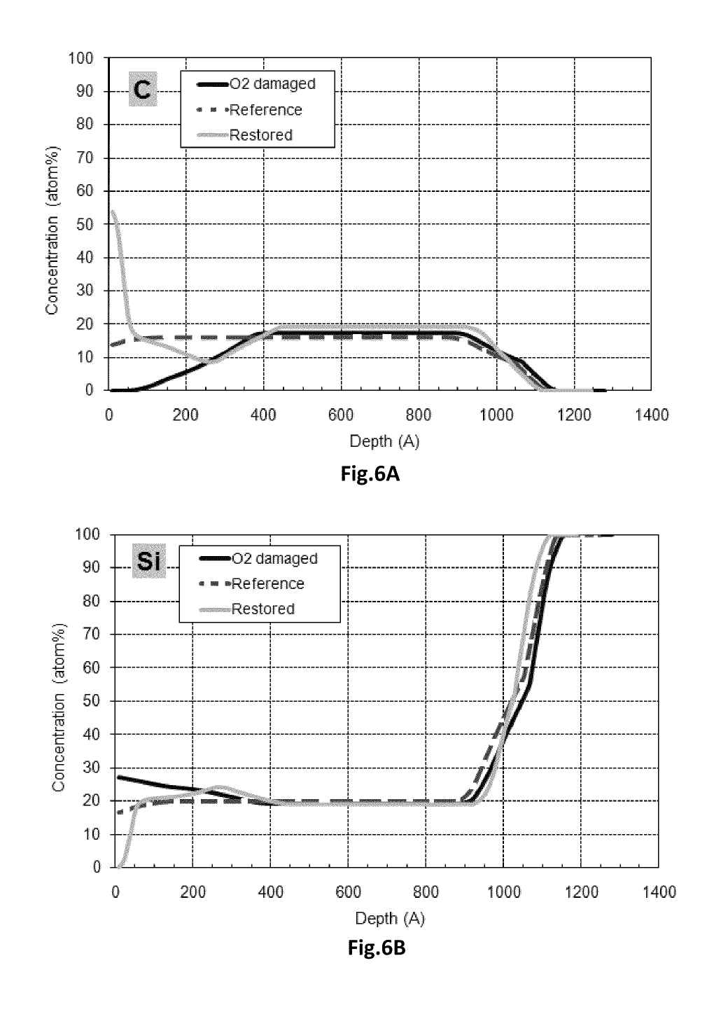

FIG. 5 is a graph showing the relationship between delta k value and FT-IR—OH area intensity of the ELK films subjected to the oxygen plasma treatment (“O2 plasma treatment”), the oxygen plasma treatment and then the thermal annealing (“Thermal annealing”), and the oxygen plasma treatment and then the UV restoration (“UV restoration”), respectively, which films were obtained above. The ELK film had a dielectric constant of 2.3 prior to the oxygen plasma treatment. As shown in FIG. 5, the dielectric constant of the oxygen plasma treated film increased to 2.74 (delta k=0.44). However, by the UV restoration, the dielectric constant of the oxygen plasma treated film significantly decreased or was restored to 2.4 (delta k=0.1), whereas by the thermal annealing, the dielectric constant of the oxygen plasma treated film slightly decreased to 2.62 (delta k=0.32). As shown in FIG. 5, the delta k value was highly linearly correlated with FT-IR-OH area intensity (normalized by thickness), i.e., the amount of —OH remaining in the film. By reducing OH bonds, the dielectric constant of films can effectively be controlled.

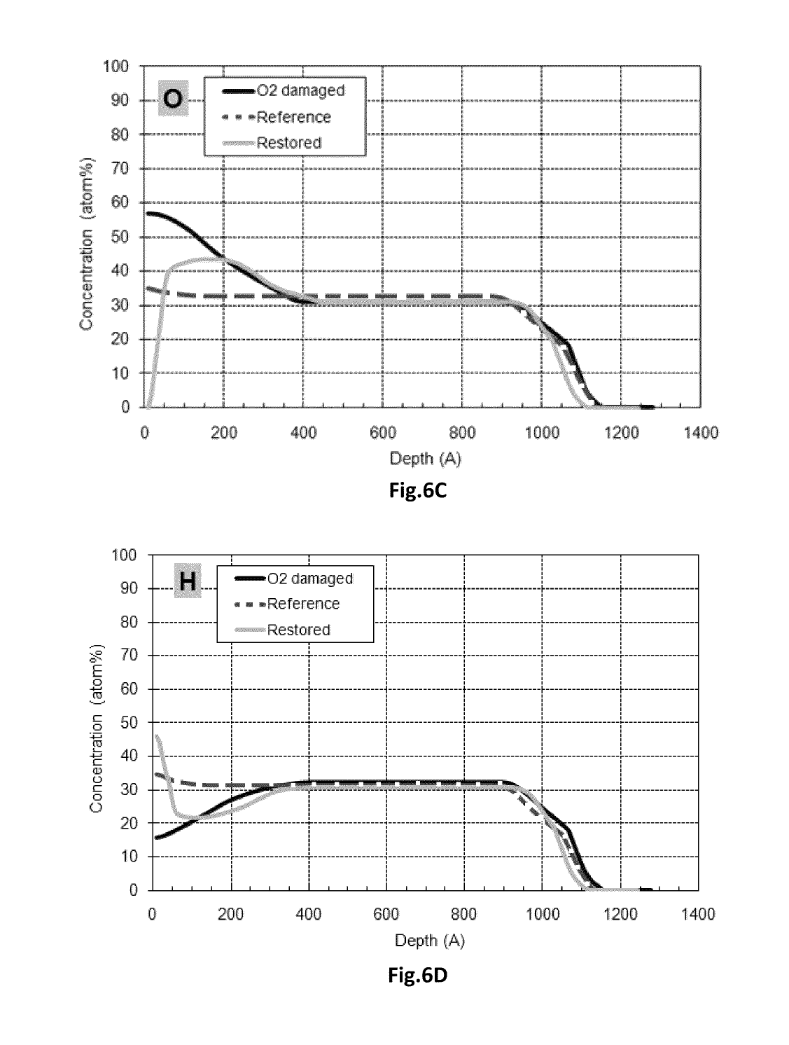

FIGS. 6A to 6D show changes of concentrations (atom %) of carbon (FIG. 6A), silicon (FIG. 6B), oxygen (FIG. 6C), and hydrogen (FIG. 6D) in relation to depth of the oxygen plasma treated film (“O2 damaged”), the reference film (“Reference”, no oxygen plasma treatment), and the UV-restored film (“Restored”) obtained above. As shown in FIG. 6A, the carbon concentration of the reference film was substantially constant in relation to depth of the film, but after the oxygen plasma treatment, the carbon concentration of the film was significantly decreased from a depth of nearly 40 nm toward the surface where the concentration of carbon became zero, indicating that the surface layer of the film was damaged by the oxygen plasma. Consistently with the above significant reduction of carbon concentration, as shown in FIG. 6C, the oxygen concentration increased in the oxygen plasma treated film, and as shown in FIG. 6D, the hydrogen concentration decreased, wherein the oxygen plasma treatment removed carbon and hydrogen and replaced them with oxygen. However, through the UV restoration treatment, excited hydrocarbon gas entered pores of the film, penetrated the damaged porous layer, and deposited a film, thereby sealing the pores. As shown in FIG. 6A, in the UV-restored film, the carbon concentration was restored from the surface to a depth as great as about 25 nm, constituting a restored layer having a thickness of about 25 nm. Also, a skin layer having a thickness of about 6 nm was formed on the restored layer as shown in FIG. 6A. Likewise, the hydrogen concentration of the UV-restored film was also restored as shown in FIG. 6D. The oxygen concentration of the UV-restored film decreased as shown in FIG. 6C, and there was substantially no oxygen in the skin layer. Additionally, as shown in FIG. 6B, the silicon concentration of each film was substantially the same, except for that of the skin layer. Since the restored layer was formed prior to the skin layer, even if the UV restoration process stops before forming the skin layer, the restored layer has substantially the same characteristics as those shown in FIGS. 6A to 6D.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A method for sealing pores at a surface of a dielectric layer formed on a substrate, comprising:
providing a substrate on which a dielectric layer having a porous surface is formed as an outermost layer;
placing the substrate in an evacuatable chamber;
irradiating the substrate with UV light in an atmosphere of hydrocarbon and/or oxy-hydrocarbon gas to seal pores at the porous surface of the dielectric layer; and
continuously irradiating the substrate with UV light in the atmosphere of hydrocarbon and/or oxy-hydrocarbon gas to form a protective film or layer having a desired thickness on the dielectric layer.

2. The method according to claim 1, wherein the step of irradiating the substrate with UV light to seal the pores is performed to restore a surface layer of the substrate while forming substantially no film thereon.

3. The method according to claim 2, wherein the surface layer of the substrate is restored at a depth of about 5 nm to about 50 nm where the pores are sealed with carbon and hydrogen derived from the hydrocarbon and/or oxy-hydrocarbon gas.

4. The method according to claim 1, wherein the protective film or layer has a thickness of about 0.1 nm to about 6 nm.

5. The method according to claim 1, wherein the porous surface of the dielectric layer receives chemical degradation prior to the step of sealing the pores.

6. The method according to claim 5, wherein the chemical degradation is etching, ashing, or cleaning.

7. The method according to claim 1, wherein the atmosphere of hydrocarbon and/or oxy-hydrocarbon gas is established by introducing a hydrocarbon and/or oxy-hydrocarbon gas without including silicon-containing gas into the evacuatable chamber.

8. The method according to claim 7, wherein the hydrocarbon and/or oxy-hydrocarbon gas consists of hydrogen and carbon.

9. The method according to claim 8, wherein the hydrocarbon and/or oxy-hydrocarbon gas is a mixture of hydrocarbon gas and oxy hydrocarbon gas.

10. The method according to claim 7, wherein the hydrocarbon and/or oxy-hydrocarbon gas is introduced with an inert gas saturated with hydrocarbon and/or oxy-hydrocarbon gas.

11. The method according to claim 10, wherein the saturated inert gas is introduced at a flow rate of 500 sccm to 10,000 sccm.

12. The method according to claim 1, wherein the UV light has a wavelength of 200 nm or higher.

13. The method according to claim 1, further comprising annealing the substrate after the protective film or layer is formed by the UV light irradiation.

14. The method according to claim 1, wherein the protective film or layer is formed on a top surface and side surfaces of the dielectric layer.

15. The method according to claim 1, wherein the dielectric layer is a SiCO film.

16. The method according to claim 1, wherein the dielectric layer has a dielectric constant of lower than 2.5.

17. The method according to claim 16, wherein the protective film or layer and the dielectric layer together have a dielectric constant which is substantially the same as that of the dielectric layer.

18. The method according to claim 1, wherein the substrate is irradiated with UV light through a transmission window which is made of synthetic quartz.

19. The method according to claim 18, further comprising cleaning the evacuatable chamber by using a cleaning gas containing no fluorine after the protective film or layer is formed.
